(19) United States
(12) Patent Application Publication
(10) Pub. No.: US 2020/0051109 A1
(43) Pub. Date: Feb. 13, 2020

(54) System and Method for Directing Reward System\Rebates to Variable Life Insurance Coverage

(71) Applicants: Daniil Tseytlonok, Alameda, CA (US); Yevgen Prudchyenko, Alameda, CA (US); David Shvarts, Saratoga, CA (US)

(72) Inventors: Daniil Tseytlonok, Alameda, CA (US); Yevgen Prudchyenko, Alameda, CA (US); David Shvarts, Saratoga, CA (US)

(21) Appl. No.: 16/537,221

(22) Filed: Aug. 9, 2019

Related U.S. Application Data
(60) Provisional application No. 62/716,873, filed on Aug. 9, 2018.

(51) Int. Cl. G06Q 30/02; G06Q 40/08

(52) U.S. Cl. CPC G06Q 30/0215; G06Q 30/0226; G06Q 40/08

(57) ABSTRACT

A system and method for directing third party deposits into a member's life insurance account includes a computer connected to the internet and with programming capable of determining if a person is a member of an online rewards entity and also is an owner of a life insurance policy of a type that increases life insurance coverage when additional monies are paid in. Then, the system and method determines a reward amount attributed to the member of the rewards entity and the reward amount is paid to the insurance company and applied to the reward member's variable insurance policy—thus increasing the amount life insurance coverage.

### REFERENCE TO RELATED APPLICATIONS

This application claims the benefit of provisional patent application U.S. Ser. No. 62/716,873 filed Aug. 9, 2018 titled Life Insurance with Variable Coverage that is Conditional upon Buy-Sell Rewards System, which is incorporated in its entirety herein by reference.

### BACKGROUND OF THE INVENTION

This invention relates to online reward systems for advertising, buying, and selling of goods and services and, more particularly, to an online rewards system that contributes to an member's life insurance coverage or account in an amount equal to rewards earned by the member and then the online rewards system or third party deposits the contributed amount, such as the value of rebates from a buy-sell system, to an insurance company by which a member has an insurance policy. The member referred to herein is a member of the online rewards program having the inventive program for contributing the member's earned rewards to the employee's own life insurance coverage or to new life insurance coverage.

Third parties, whether online buy-sell rewards systems, relatives, or others desiring to give a gift of life insurance to another person, often do not have a good way to transfer such a gift. One way to do this would be contributing to the other person's life insurance coverage or account. Unfortunately, there is currently no efficient way for a reward system to contribute, on behalf of an insured and member of the rewards program, directly to the life insurance provider.

Therefore, it would be desirable to have an online rewards system or other third party that facilitates a contribution to an member's life insurance account in an amount equal to rewards earned by the member.

### SUMMARY OF THE INVENTION

A system and method for directing third party deposits into a member's life insurance account according to the present invention includes a computer connected to the internet and with programming capable of determining if a person is a member of an online rewards entity and also is an owner of a life insurance policy of a type that increases life insurance coverage when additional monies are paid in. Then, the system and method determines a reward amount attributed to the member of the rewards entity and the reward amount is paid to the insurance company and applied to the reward member's variable insurance policy—thus increasing the amount life insurance coverage.

Therefore, a general object of this invention is to provide a system and method for providing an online rewards system or third party system to contribute, on behalf of a member and using the member's attributed rewards, to a member's life insurance account.

A further object of this invention is to provide a system and method as aforesaid, for crediting the account of its participants in life insurance or, in appropriate circumstances, adding to the member's life insurance coverage.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a block diagram of a system and method enabling third parties, such as an online buy-sell or other rewards system to direct those reward points (converted to cash value) directly to an insurance provider so as to benefit a member of the rewards program who is also an insured of the insurance company, illustrated to show the system and flow of data; and

FIG. 2 is a block diagram of the system and method as in FIG. 1, illustrated to show a flow of financial funding of the member/employee and insurance contribution.

### DESCRIPTION OF THE PREFERRED EMBODIMENT

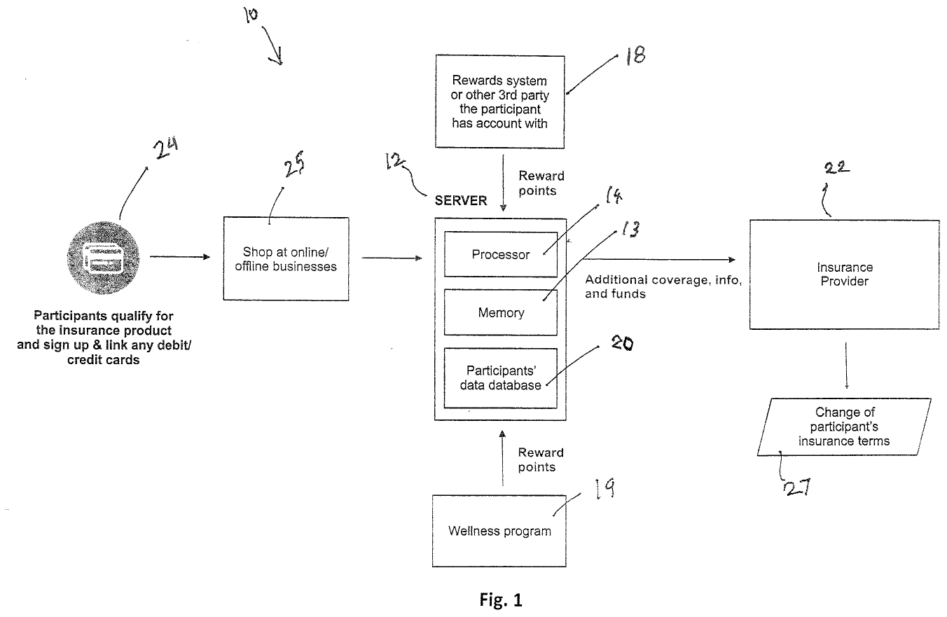

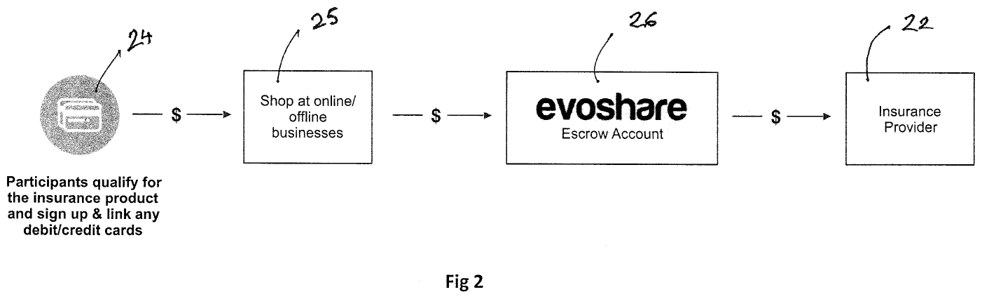

An online system and method enabling an online rewards system to contribute awards attributed to a member directly to an insurance provider associated with the member's life insurance policy will now be described in detail with reference to FIGS. 1 to 2 of the accompanying drawings. More particularly, the system and method 10 enabling third parties to deposit funds into an employer sponsored insurance account associated with an employee includes at least one computer 12 such as a network server, operably connected to a wide area network such as the internet and accessible by remote computers in a traditional manner (FIG. 1). Specifically, the system 10 is designed to be used by buyers to view and purchase products offered by sellers and also to calculate rewards attributable to a buyer and facilitate contributions to an insurer of the member using the attributable rewards of the member as will be described later. The system 10 may be configured and managed by an administrator having security access to all aspects of the computer and memory, including data and programming. The present invention, however, includes more than merely a computer executing programming steps as will be disclosed below.

The computer 12 may include a non-volatile memory 13 configured to store a plurality of programming instructions and includes a processor 14 configured to selectively execute the program instructions in a manner that operates the system 10 as will be described below. The memory 13 may also be structured so as to store a plurality of data structures such as one or more databases and data that may be stored and manipulated by operation of the programming instructions.

Data structures stored in the memory 13 may include, but are not limited to, the databases described below. The system 10 may include a member database 20 that may include a plurality of member records associated with a member or participant in the rewards program (FIG. 2). Each record may include, but not be limited to, login data, contact or address data, reward data, and other data.

It is understood that the member of the reward program 18 discussed herein also has a life insurance contract with an insurance company 22. The terms of some life insurance policies, such as whole life policies, may allow increased life insurance coverage to be added to the policy as further investments are made while other policies, such as basic term life insurance contracts are for a fixed amount only but have premiums that must be paid regularly. Variable insurance policies that may be included in the present system include, but are not limited to, simple variable term, minimum term with variable option, regular term with variable payments, variable value, or combinations thereof.

A person may become a member of an online rewards program 22 which assigns credit to the member as participating products are purchased. The online rewards program 22 is illustrated in FIG. 1 and its components are described above. The member may be required to opt in to this program and may be assigned an identification number, i.e. an account number identifying the member and his account. It will be understood that the reward program 22 referred to herein may include any rewards system that attributes rewards, cash back, miles, credit cards, wellness credits from a wellness program 19, or other rewards to its members based on purchases or use of products. Further, the member may also be an insured associated with an insurance provider 22 and own any of a host of insurance products, examples of which are explained in the following paragraph—again as exemplary examples but not by way of limitation. The present invention is simply a new and innovative feature that a participating insurance provider 22 may provide to its insureds.

Preferably, the present invention applies to variable term life insurance such that payment on a policy holder's account increases the level of coverage although using attributable rewards may be used merely to pay monthly premiums of a fixed term life policy as well. Other insurance products that may be increased by rewards payments are described below. One of the insurance products may be simple variable term life insurance, where said credits to the account, possibly averaged or otherwise processed, are used as a sole source of funding the term life insurance over a pre-agreed upon or computed period of time. Another of the insurance products may be minimum term life insurance with variable option, where a participant buys a term life insurance and then said credits to the account, possibly averaged or otherwise processed, are used as an additional source of funding the optional variable part of term life insurance over a pre-agreed upon or computed period of time. Yet another of the insurance products may be regular term life insurance with variable payments, where a participant buys a term life insurance and then said credits to the account, possibly averaged or otherwise processed, are used as an additional source of funding to reduce original payments over a pre-agreed upon or computed period of time. Yet another of the insurance products may be variable cash-value whole life insurance, where a participant buys whole life insurance, and then said credits to the account, possibly averaged or otherwise processed, are used as an additional source of funding the cash-value of the whole life insurance. Said term life insurance products can be applied to a term part of a whole life insurance and combined with any variable cash-value product.

In use, the processor 14, executing respective programming instructions, is capable of calculating rewards attributable to a member (e.g. 2% cash back), and then contributing that amount, such as by wire transfer or other funds transfer, to the member's insurance account. More particularly, the member must qualify for an insurance product such as one of the product's described above, as indicated at block 24 (FIG. 2). It is further assumed that the member is also a participant in a rewards program 22 and that there is communication between the insurance provider 22 and rewards program 22, preferably electronically such as online so that this process is entirely automatic. For instance, the user may earn cash back by shopping at participating stores whether online or locally, such as shown at block 25 (FIG. 1). Accordingly, when rewards are attributed to the member, according to the particular rewards program 22, the processor 14 will direct all or a portion of the rewards points first to an escrow account 26 and, from there, to the insurance provider 22 associated with the insurance product.

As described above, payments (or credits) to the insured's account via a member and insured's online rewards will increase the amount of the life insurance coverage, pay premiums, or the like. In other words, contributions may actually change the terms of the policy as originally written, as shown in block 27.

It is understood that while certain forms of this invention have been illustrated and described, it is not limited thereto except insofar as such limitations are included in the following claims and allowable functional equivalents thereof.

1. A system for directing earned rewards from a third party rewards program to an insurance provider on behalf of a member of the rewards program, said system comprising:
a computer server having a processor connected to the wide area network and that provides a user interface to the network;
a non-volatile memory in said computer server in data communication with said processor and configured to store programming and data structures;
programming in said memory that, when executed by said processor, causes said processor to:
determine if the member is a member of the rewards program and, if so, calculate a reward amount equal to at least a portion of rewards attributed to the member according to terms of the rewards program;
determine if the member has an insurance policy subject to life insurance coverage and, if so,
direct a monetary payment in an amount equal to said calculated reward amount to an insurance provider associated with said insurance policy of the member.

2. The system as in claim 1, wherein said programming, when executed by said processor causes said processor to direct said monetary payment to an escrow account associated with the rewards program and which has predetermined instructions to direct said monetary payment to said insurance provider.

3. The system as in claim 1, further comprising a member database stored in said memory and in data communication with said processor and having a unique member identification number, member address, and member banking data associated with each member of the rewards entity.

4. The system as in claim 1, wherein said programming, when executed by said processor, causes said processor to repeat, according to a predetermined time regularity, the steps of calculating the amount of rewards attributable to the member and directing a monetary payment to said insurance company associated with said insurance policy of the member.

5. The system as in claim 1, wherein said rewards entity is the EvoShare buy-sell system that gives cash-back to its members as a result of spending at predetermined vendors.

6. The system as in claim 1, wherein said insurance policy associated with the member is taken from a group comprising, simple variable term life insurance, minimum term life insurance with a variable option, regular term life insurance with variable payments, and variable cash-value whole life insurance.

7. A method for directing earned rewards from a third party rewards program to an insurance provider on behalf of a member of the rewards program, said method comprising:
determining if the member is a member of the rewards program and, if so, calculating a reward amount equal to at least a portion of rewards attributed to the member according to terms of the rewards program;
determining if the member has an insurance policy indicative of variable life insurance coverage and, if so,
directing a monetary payment in an amount equal to said calculated reward amount to an insurance provider associated with said insurance policy of the member.

8. The method as in claim 7, further comprising repeating the steps of receiving said reward amount and directing said monetary payment of said reward amount to said insurance provider on a predetermined regular basis.

9. The method as in claim 7, wherein said rewards entity is the EvoShare™ buy-sell rewards system that provides cash back rewards as a result of spending and is operable to make payments to insurance providers of its members using the member's own rewards.
